(19) United States
(12) Patent Application Publication
(10) Pub. No.: US 2011/0056349 A1
(43) Pub. Date: Mar. 10, 2011

(54) Apparatus to Feed and Shear Metal Bars, and Relative Method

(75) Inventor: Giorgio Del Fabro, Udine (IT)

(73) Assignee: M.E.P. Macchine Elettroniche Piegatrici SpA, Reana del Rojale (IT)

(21) Appl. No.: 12/991,285

(22) PCT Filed: May 5, 2009
(86) PCT No.: PCT/EP2009/055379

§ 371 Date: Nov. 5, 2010

(30) Foreign Application Priority Data
May 6, 2008 (IT) UD2008A000097

(51) Int. Cl. B26D 7/06

(52) U.S. Cl. 83/35; 83/418

(57) ABSTRACT

An apparatus and method to feed and shear metal bars, comprising a shearing unit that shears the metal bars sequentially into segments of desired length, and an alignment and translation unit, which feeds the metal bars to the shearing unit, provided with butting member suitable to cooperate with the tail ends of the metal bars in order to align them longitudinally with respect to each other. The butting member comprises a magnetic portion facing toward the tail ends of the metal bars, and conformed so as to generate a magnetic or electromagnetic attraction force on the tail ends, so as to attract the metal bars to itself and to keep the relative tail ends substantially aligned and in contact with the butting member.

### BACKGROUND OF THE INVENTION

1. Field of the Invention

The present invention concerns an apparatus to feed and shear metal bars and the relative method, usable in association with automatic machines, such as for example stirrup machines, bending machines, shaping machines, binding machines, storage apparatuses or other machines for working or storing bars sheared to size. In particular, the apparatus according to the invention allows to feed, substantially continuously, metal bars sheared to size to an automatic machine, eliminating down times and waiting times, facilitating the discharge of the off-cuts and increasing shearing accuracy and productivity of the machine.

2. Description of Related Art

Automatic machines for working metal bars sheared to size are known, such as for example stirrup machines, bending machines, shaping machines, binding machines or others, which work one or more bars at a time in order to produce shaped products for the building trade or other type of product. Stores are also known, suitable to collect segments of bars sheared to size.

Upstream of such machines, or upstream of the collection stores, a feed store is normally provided in which bars of different diameter are disposed in homogeneous bundles, and from which the bars to be sent to the machine are picked up on each occasion, according to the specific requirements.

Apparatuses are also known, disposed between the feed store and the automatic machine, and provided with shearing units suitable to feed to the machine segments of bars of the desired length.

It is known that, in order to guarantee the correct measurement and sequential shearing of the bars to be sent to the machine, the latter are first aligned with each other on a positioning and transport plane, upstream of the shearing unit, by butting the leading ends, and subsequently transported by a transport member, for example with rollers, belt, chain or other, toward and beyond the shearing unit. The bars are moved until they are taken into abutment with their leading ends, against specific stop elements positioned at fixed pitches downstream of the shearing unit, and able to define the sheared measurements of the bars.

Some known apparatuses also have the possibility of moving the positioning and transport plane and the shearing unit with respect to each other, so as to adjust the shearing of the bars to measurements different from those defined by the fixed pitches of the stop elements.

This type of known apparatus not only has to provide different movement means for the shearing unit and/or the plane, and also members to activate the stop elements, but also effect a butting operation on the lead ends of the bars, thus causing a tail-end excess or off-cut, due to the difference between the multiple sizes of the segments sheared and the initial length of the individual bars.

One of the main disadvantages of this type of known apparatus is the problem of discharging said off-cuts, to allow to start shearing new bars.

Shearing apparatuses are also known in which the alignment unit comprises a butting member suitable to cooperate with the tail ends of the metal bars in order to align them longitudinally with respect to each other, and a thruster member configured to thrust the metal bars acting on their tail ends, to take them toward and beyond the shearing unit.

The thruster member acts until it takes the tail ends to a predetermined initial distance from the shearing unit. The distance is advantageously a multiple of the measurement of the individual segments into which the metal bars are to be divided.

This last type of known apparatus allows to discharge the off-cuts before starting the shearing steps, giving advantages in terms of time and costs of production.

Under some operating conditions, however, it is possible that the bars, butted by their tail end, especially during the thrusting step and with bars having a medium/small diameter, reciprocally move due to inertia, thus partly losing their butted condition. Furthermore, difficulties have been found in guaranteeing an effective contact between the butting member and the tail ends of all the bars to be butted.

One purpose of the present invention is to produce an apparatus to feed and shear metal bars that allows to considerably reduce the down times due to the operations to discharge the off-cuts, without providing complex members to pick up and discharge them.

Another purpose of the present invention is to produce an apparatus that guarantees that the initial alignment of all the bars is maintained, both in the butting step and also during all the sequential shearing steps.

The Applicant has devised, tested and embodied the present invention to overcome the shortcomings of the state of the art and to obtain these and other purposes and advantages.

### BRIEF SUMMARY OF THE INVENTION

The present invention is set forth and characterized in the independent claims, while the dependent claims describe other characteristics of the invention or variants to the main inventive idea.

An apparatus according to the present invention is applied to feed metal bars to an automatic machine, and to shear said bars into segments.

The apparatus according to the present invention comprises at least a shearing unit able to shear the metal bars sequentially into segments of a desired length and to feed them to a work machine, and an alignment and translation unit which feeds the metal bars to the shearing unit and is provided with a butting member suitable to cooperate with the tail ends of the bars so as to align them longitudinally with respect to each other.

According to a characteristic feature of the present invention, the butting member comprises at least a magnetic portion, facing toward the tail ends of the metal bars. The magnetic portion is conformed so as to generate a magnetic or electromagnetic force of attraction on the tail ends of the metal bars, so as to attract them towards itself and keep the relative tail ends substantially aligned and in contact with the butting member, also during any possible reciprocal movements of the bars during the butting and thrusting operations.

In this way, the tail ends of the metal bars are magnetically attracted and remain attracted by the magnetic portion of the butting member. This guarantees that all the metal bars, even those of average/small diameter, contact the butting member during the butting step with their tail end, and are thus all equally butted.

Furthermore, since the butting is carried out on the tail ends of the metal bars, there is a single butting operation, in an initial step that precedes the shearing to size step, to define the positioning of the off-cut to be sheared and discharged downstream of the shearing unit and in the same direction of feed of the bars. This gives a considerable advantage in the continuity of feed of the metal bars to be sheared and therefore the segments to be fed to the automatic machine.

The functional combination of the tail-wise butting and the action of magnetic attraction exerted by the butting member guarantees a substantially uniform shearing and positioning of the metal bars, and hence great accuracy and repeatability in making the segments of bars exiting from the shearing cycle.

According to a variant, the magnetic portion comprises an electromagnet able to be selectively activated and/or adjusted, according to the different operating steps and/or types of metal bars.

According to another variant, the magnetic portion comprises a permanent magnet.

According to a variant, the butting member is selectively mobile with respect to the shearing unit, in a direction substantially parallel to the longitudinal axis of the bars, so as to function as a thruster too, acting on the tail ends of the metal bars, to take them toward and beyond the shearing unit.

In this solution, the metal bars subjected to longitudinal thrust are substantially prevented from making uncontrolled reciprocal longitudinal movements due to inertia, since they all remain in contact with the butting member, due to the action of magnetic attraction effected by the magnetic portion.

Therefore, there is a substantial guarantee that the movement and shearing effected are substantially equivalent for all the metal bars fed, giving the advantage of uniformity and accuracy of the segments, and the length of the latter can be defined only by controlling the advance of the butting member.

According to a variant, the alignment unit comprises a butting member and a thruster member operatively independent of each other and able to act on the tail ends of the metal bars at different times and in different ways.

According to another variant, the butting member in its operating thrust condition, or the thruster member when provided independent, acts until it takes the tail ends to a predetermined initial distance from the shearing unit. This distance is advantageously a multiple of the measurement of the individual segments into which the metal bars are to be divided.

In this way the off-cuts, that is, the part of the bar that exceeds the multiple of the length of the individual segment, are generated in correspondence with the leading ends of the bars and no longer in correspondence with the tail ends, facilitating the discharge of the off-cuts.

According to another variant, downstream of the shearing unit there is a distribution means that selectively directs the segments sheared into specific containing baskets and/or toward one or more automatic working machines.

### BRIEF DESCRIPTION OF THE SEVERAL VIEWS OF THE DRAWINGS

These and other characteristics of the present invention will become apparent from the following description of a preferential form of embodiment, given as a non-restrictive example with reference to the attached drawings wherein:

FIG. 1 is a schematic plane view of an apparatus to feed and shear metal bars according to the present invention, in a first operating step;

FIG. 2 is a schematic plane view of the apparatus in FIG. 1, in a second operating step;

FIG. 3 is a schematic plane view of the apparatus in FIG. 1, in a third operating step;

FIG. 4 is a schematic plane view of the apparatus in FIG. 1, in a fourth operating step;

FIG. 5 is a schematic plane view of the apparatus in FIG. 1, in a fifth operating step;

FIG. 6 is a schematic plane view of the apparatus in FIG. 1, in a sixth operating step;

FIG. 7 is a schematic plane view of the apparatus in FIG. 1, in a seventh operating step;

FIG. 8 is a schematic lateral view of an enlarged detail of the apparatus in FIG. 1.

### DETAILED DESCRIPTION OF THE INVENTION

With reference to the attached drawings, an apparatus 10 according to the present invention is configured to feed and shear, substantially continuously, a plurality of metal bars 11 into segments 12 of a desired length, and to feed them to one or more automatic machines, of a known type and not shown here, for example a stirrup-making machine, a caging machine, a store or other analogous or comparable machine.

In particular, the apparatus 10 according to the invention is suitable to pick up the metal bars 11 from a feed store, also of a known type and not shown here, in which the latter are grouped together, according to their diameter, in a plurality of homogeneous bundles, for example disposed adjacent to each other.

The apparatus 10 according to the invention comprises in sequence a feed unit 13 that allows to feed the metal bars 11, an alignment and translation unit 15 that allows to align the metal bars 11 fed by the feed unit 13 and moves them in a guided manner toward a predefined shearing axis “C”, and shears 16 that make the segments 12 from the metal bars 11 moved by the feed unit 13.

The shears 16 are of a substantially known type and will not be described in detail here; they are able to shear the bars 11 into segments 12 along the shearing axis “C”.

In particular, the feed unit 13 comprises a plane 14 provided with rollers, chains or other translation means, able to act longitudinally on the bars 11 so as to take them into correspondence with the alignment and translation unit 15.

The plane 14 also comprises, pivoted in correspondence with one flank facing toward the alignment and translation unit 15, a plurality of stopping levers 18 which selectively allow to hold the metal bars 11 temporarily on the plane 14, or to feed them to the alignment and translation unit 15.

The alignment and translation unit 15 comprises a butting member 17 positioned substantially parallel to the feed unit 13, and suitable to cooperate with the tail ends 11a of the metal bars 11 picked up from the feed store, so as to align the metal bars 11 longitudinally with respect to the tail ends 11a, and thus carry out a tail-wise butting of the bars 11.

In this case, the butting member 17 comprises an abutment wall 20 against which the tail ends 11a of the metal bars 11 rest, reciprocally aligned, thus carrying out a tail-wise butting of the bars 11.

The abutment wall 20 comprises an abutment surface 20a, on which a magnetic portion 19 is provided, facing toward the tail ends 11a of the metal bars 11.

In this way, the tail ends 11a of the metal bars 11 are attracted into contact with the abutment surface 20a by the force of magnetic attraction generated by the magnetic portion 19, and then all held against the abutment wall 20, to be uniformly butted with respect to the relative tail ends 11a.

In this case, the magnetic portion 19 comprises one or more electromagnets, of a substantially known type, which are able to be selectively activated and modulated in order to drive/regulate the magnetic attraction on the tail ends 11a of the metal bars 11.

According to a variant, the magnetic portion 19 comprises one or more permanent magnets, each generating a determinate force of magnetic attraction.

The abutment wall 20 is selectively mobile toward the shearing axis “C”, so as to progressively thrust the metal bars 11, as will be described in more detail hereafter, into association with the shears 16 and, at the same time, keep them butted tail-wise by means of the action of the magnetic portion 19.

In this case the abutment wall 20 is associated at the rear with a thruster member 21 disposed substantially parallel to the direction of feed of the bars 11, and able to thrust selectively the abutment wall 20 to move the metal bars 11 toward the shears 16.

A position transducer 30 is associated with the thruster member 21, and allows to verify the entity of the linear advance of the metal bars 11 held by the magnetic portion 19 of the abutment wall 20, and to easily calculate the distance “D” of the abutment wall 20 with respect to the shears 16.

The alignment and translation unit 15 comprises a first transport member 23 disposed downstream of the abutment wall 20 and in line with and upstream of the shears 16, and a second transport member 25 disposed downstream and in line with the shears 16.

In this case, both the first transport member 23 and the second transport member 25 substantially consist of a rollerway 24, on which the metal bars 11 slide, moved by the moving abutment wall 20.

The first transport member 23 also comprises a lateral shoulder 31, able to hold the metal bars 11 laterally before shearing.

According to a variant, one or both of the first transport member 23 and the second transport member 25 substantially consists of a driven conveyor belt provided externally with a plurality of magnetic elements disposed transverse to the metal bars 11, so as to effect a controlled transport of the latter.

The alignment and translation unit 15 also comprises a distribution member 26, associated downstream and in parallel with the second transport member 25, and able to direct the segments of bar 12 toward relative automatic machines, stores or other users.

In this case the distribution member 26 comprises a rollerway disposed and configured so as to move the segments 12 parallel to the axis of movement of the metal bars 11 along the rollerway 24, that is, forward or backward, with respect to the normal direction of feed of the metal bars 11.

The method according to the present invention to feed and shear segments 12 starting from metal bars 11 with the apparatus 10 as described heretofore is as follows.

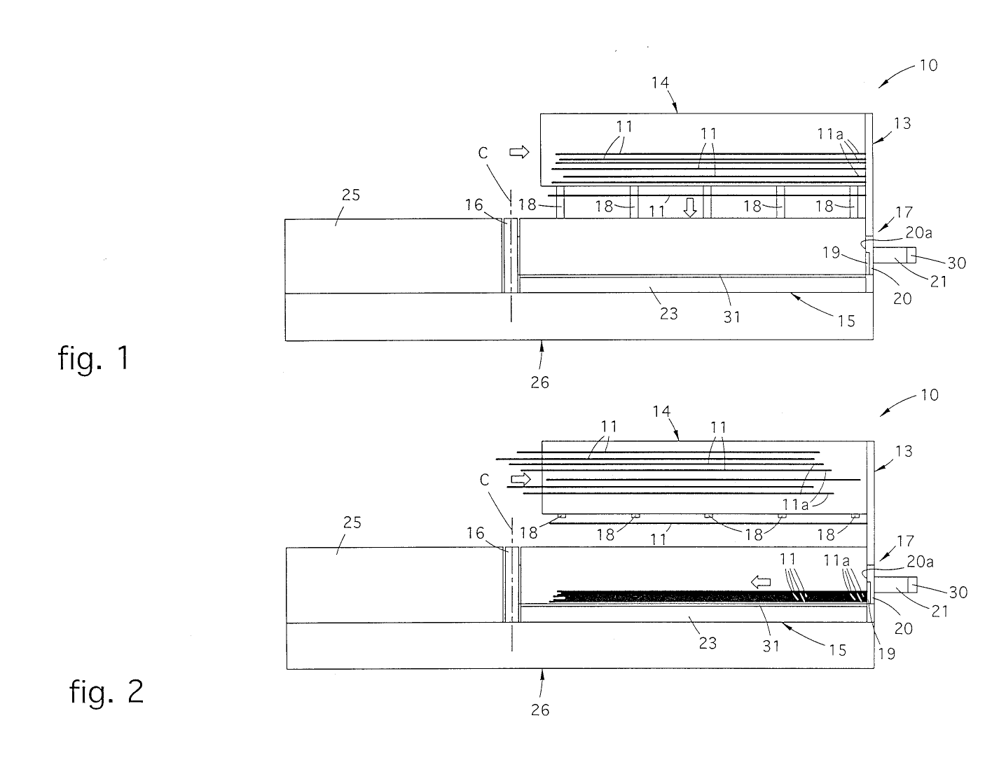

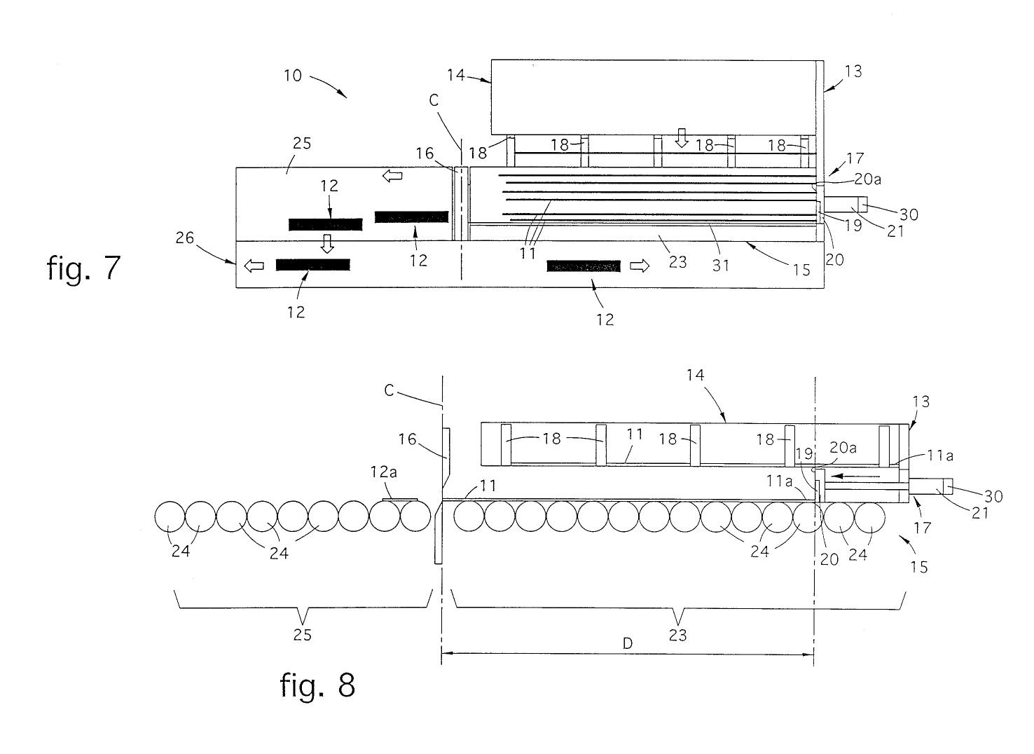

With reference to FIGS. 1 to 7, in a first step of the method according to the present invention, a plurality of metal bars 11 are fed from the feed store and, once on the plane 14, are fed toward the alignment and translation unit 15 by means of the stopping levers 18 (FIG. 1).

The metal bars 11 are then positioned on the first transport member 23 close to the lateral shoulder 31, and the abutment wall 20 is made to advance by the thruster member 21 until it contacts the tail ends 11a of the metal bars 11.

Thanks to the action of the magnetic portion 19, all the tail ends 11a of the metal bars 11 move into contact with the abutment surface 20a of the abutment wall 20 (FIG. 2).

Simultaneously, the stopping levers 18 are raised, and a new plurality of metal bars 11 are fed onto the plane 14.

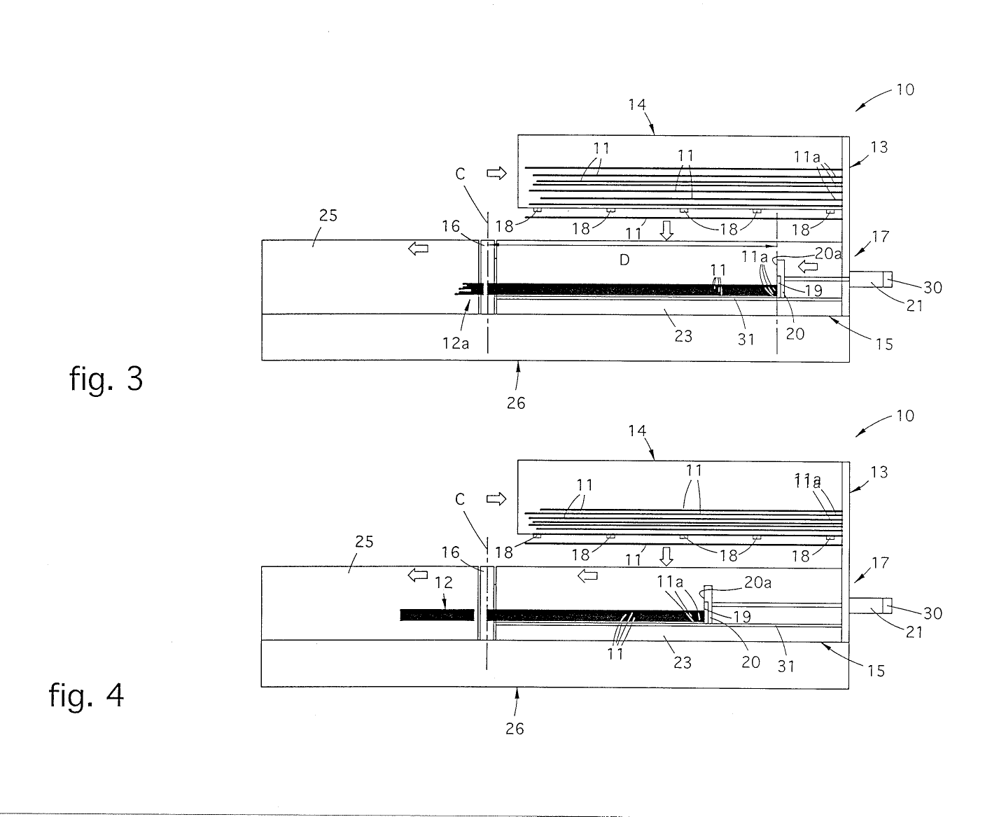

Subsequently the thruster member 21 is activated, which thrusts the metal bars 11 longitudinally by means of the abutment wall 20 until it takes their tail ends 11a to a determinate distance “D” from the shears 16. The distance D is chosen as a function of the initial length of the metal bars 11 and the number and length of the individual segments 12 to be made (FIGS. 3 and 8).

For example, if we want to make four segments 12 of about 3 meters each, from metal bars 11 of about 13 meters, the distance D is set at about 12 meters. In this way, the metal bars 11 pass beyond the shears 16 with their leading ends, defining downstream of the shears 16 relative off-cuts 12a with a length of about 1 meter.

The off-cuts 12a are thus picked up by the second transport member 25 and discharged by the latter to a zone immediately downstream of the shears 16.

At this point the abutment wall 20 keeps the metal bars 11 to be sheared aligned and moves them, making them advance progressively by a determinate amount.

The amount the metal bars 11 are fed toward the shears 16 is commanded by the thruster member 21 and controlled by the position transducer 30, thus guaranteeing the uniform shearing of the various segments 12.

The second transport member 25 moves the sheared segments 12 in a coordinated manner.

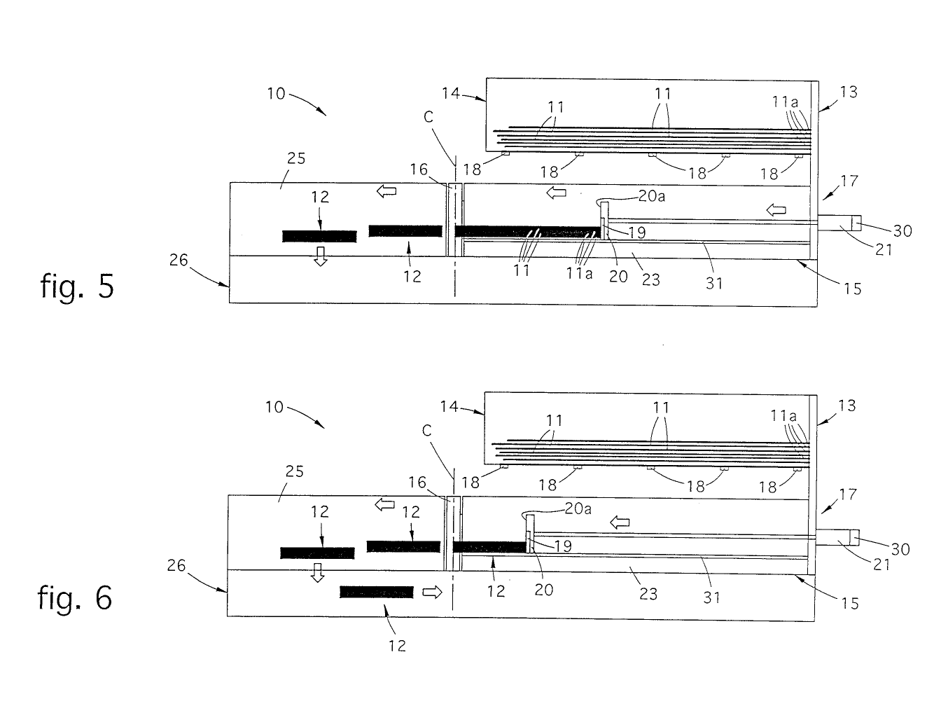

Subsequently, as shown in sequence in FIGS. 5, 6 and 7, the sheared segments 12 are alternately moved by the distribution member 26, forward and backward with respect to the feed imparted to them by the second transport member 25.

At the same time as the last cut is made to the metal bars 11, the stopping levers 18 are lowered, allowing new metal bars 11 butted tail-wise to be positioned on the first transport member 23 and immediately start a new shearing and feeding cycle.

It is clear however that modifications and/or additions of parts may be made to the apparatus 10 as described heretofore, without departing from the field and scope of the present invention.

It is also clear that, although the present invention has been described with reference to specific examples, a person of skill in the art shall certainly be able to achieve many other equivalent forms of apparatus to feed and shear metal bars, and relative method, having the characteristics as set forth in the claims and hence all coming within the field of protection defined thereby.

1. An apparatus to feed and shear metal bars, comprising at least a shearing unit able to shear said metal bars sequentially into segments of desired length, and an alignment and translation unit, able to feed said metal bars to said shearing unit, provided with a butting member suitable to cooperate with the tail ends of said metal bars in order to align them longitudinally with respect to each other, wherein said butting member comprises at least a magnetic portion facing toward the tail ends of said metal bars, and conformed so as to generate a magnetic or electromagnetic attraction force on said tail ends, so as to attract said metal bars to itself and to keep the relative tail ends substantially aligned and in contact with said butting member.

2. The apparatus as in claim 1, wherein said magnetic portion comprises an electromagnet, able to be selectively activated and/or adjusted, as a function of the different operating steps and/or types of metal bars.

3. The apparatus as in claim 1, wherein said magnetic portion comprises a permanent magnet.

4. The apparatus as in claim 1, wherein said butting member is selectively mobile with respect to said shearing unit in a direction substantially parallel to a longitudinal axis of said metal bars, so as to function as a thruster too, acting on the tail ends of the metal bars, to take them toward and beyond the shearing unit.

5. The apparatus as in claim 1, wherein said butting member comprises an abutment wall against which the tail ends of the metal bars fed are able to rest.

6. The apparatus as in claim 5, wherein said abutment wall comprises an abutment surface, on which said magnetic portion is provided, facing toward the tail ends of the metal bars.

7. The apparatus as in claim 1, wherein said alignment and translation unit comprises a butting member and a thruster member operatively independent of each other and able to act on the tail ends of the metal bars at different times and in different ways.

8. The apparatus as in claim 1, comprising distribution means disposed downstream of said shearing unit and able to selectively direct the segments sheared into specific containing baskets and/or toward one or more automatic work machines.

9. A method to feed and shear metal bars, comprising at least a first step in which a plurality of said metal bars are aligned longitudinally by means of an alignment and translation unit; a second step in which said aligned metal bars are fed to at least a shearing unit; and a third step in which said metal bars are sheared sequentially into segments of a desired length by means of said shearing unit, wherein in said first step at least a first substep is provided in which said metal bars are aligned longitudinally with respect to each other by the action of a butting member acting on the respective tail ends and provided with at least a magnetic portion facing toward the tail ends of said metal bars, and conformed so as to generate a magnetic or electromagnetic attraction force on said tail ends, so as to attract said metal bars to itself and to keep the relative tail ends substantially aligned and in contact with said butting member.

10. The method as in claim 9, wherein in said first step a second substep is provided in which said metal bars are thrust by their tail ends by said butting member, until said metal bars are taken toward and beyond said shearing unit.

11. The method as in claim 10, wherein said butting member thrusts said metal bars at least until it said butting member takes said tail ends to a predetermined initial distance (D) from said shearing unit.

12. The method as in claim 11, wherein said predetermined initial distance (D) is a multiple of the measurement and number of said segments into which said metal bars are to be divided.
